(19) United States
(12) Patent Application Publication
(10) Pub. No.: US 2011/0134492 A1
(43) Pub. Date: Jun. 9, 2011

(54) IMAGE PROCESSING APPARATUS AND CONTROLLING METHOD FOR THE SAME

(75) Inventor: Shuichi Tsutsumi, Kawasaki-shi (JP)

(73) Assignee: CANON KABUSHIKI KAISHA, Tokyo (JP)

(21) Appl. No.: 12/957,911

(22) Filed: Dec. 1, 2010

(30) Foreign Application Priority Data
Dec. 9, 2009 (JP) 2009-279577

(51) Int. Cl. H04N 1/40

(52) U.S. Cl. 358/462

(57) ABSTRACT

When originals whose types are mixed are checked, problems exist as follows. If an original is missing from the originals, or if the order of some originals is wrong in the originals, the check is performed in accordance with a processing instruction which is different from a processing instruction originally expected to be applied. The reliability of the check result is accordingly deteriorated. Pieces of processing instruction information, which are as many as originals having different formats, for performing a check process on predetermined entry items in originals having a predetermined format are beforehand stored. A piece of image data on each original is obtained by reading the multiple originals to be checked. Subsequently, the check process is performed on the obtained piece of image data on an original by sequentially applying the as many pieces of processing instruction information as the originals having the different form.

### BACKGROUND OF THE INVENTION

1. Field of the Invention

The present invention relates to: an image processing apparatus which uses image data obtained by reading an image on an original and determines whether or not a predetermined item has been filled out or entered in a predetermined field of the original; a controlling method for the same; and a program.

2. Description of the Related Art

There has been heretofore a technology for a computer to analyze an image read from a sheet by a scanner, and to recognize characters and the like which have been filled out or entered (hereinafter generally called as “entered”) in a predetermined field on the sheet.

The use of this technology makes it possible, for example, to easily extract amounts, dates and the like which have been entered on numerous forms sharing the same format; and to input the extracted pieces of data in a process such as counting.

For example, Japanese Patent Laid-Open No. 2008-145611 discloses the following technology. Specifically, a user puts a processing instruction, by handwriting, on an original (a test answer sheet), which has the same format as originals to be checked, the processing instruction specifying a region to be processed and the content of the process. Subsequently, the original on which this processing instruction has been put is read by a scanner; thereby, the region to be processed and the content of the process are identified, and pieces of processing instruction information are thus obtained. Thereafter, information written in the region to be processed, which has been entered in the original to be checked, is extracted by use of the obtained pieces of processing instruction information.

Nevertheless, when a plurality of sets of originals having multiple formats mixed are to be checked in accordance with the above-mentioned processing instruction, the originals, for example, are likely to lack some pages in the middle, or to be arranged in a wrong order. In this case, the prior art makes a check in accordance with a processing instruction different from the processing instruction which is originally expected to be applied. As a result, the prior art entails problems that: it is impossible to discriminate whether an error-indicating check result comes from the actually-entered content or from an influence of lack of some pages from the originals in the middle and the like; and the reliability of the check result is accordingly low.

### SUMMARY OF THE INVENTION

An image processing apparatus according to the present invention includes: reading means configured to read multiple sets each including multiple originals having different formats and a predetermined arrangement order, and to obtain a piece of image data on each original; storage means configured to store as many pieces of processing instruction information as the originals in one set in association with information on the arrangement order of the originals, each of the pieces of the processing instruction information being used for performing a check process on entered items in one original; check means configured to perform the check process on the obtained piece of image data on an original by applying one of the pieces of processing instruction information, which are stored in the storage means, on a basis of the information on the arrangement order of the originals; control means configured to make control for the check to be performed by applying a different one of the pieces of processing instruction information, which are stored in the storage means, in a case where a result of the check process indicates an error; and means configured to perform a subsequent check by shifting correspondence between the originals and the pieces of processing instruction information applied to the originals in a case where a result of the check performed by applying the different pieces of processing instruction information indicates no error in the check performed by the control means.

The present invention makes it possible to inhibit the deterioration in the reliability of a check result in a case where multiple originals having different formats are checked.

Further features of the present invention will become apparent from the following description of exemplary embodiments (with reference to the attached drawings).

### BRIEF DESCRIPTION OF THE DRAWINGS

FIG. 1 is a block diagram showing a configuration of an image processing apparatus according to embodiments of the present invention;

FIGS. 2A to 2C are diagrams each showing an example of an original to be processed according to the embodiments of the present invention;

FIG. 3 is a flowchart showing a process flow for generating a scan ticket according to Embodiment 1;

FIG. 4 is a flowchart showing a process flow for checking originals by use of the scan ticket according to Embodiment 1;

FIG. 5 is a flowchart showing a process flow for checking originals by use of a scan ticket according to Embodiment 2;

FIG. 6 is a flowchart showing a process flow for generating a scan ticket according to Embodiment 3;

FIG. 7 is a diagram showing an example of a pattern table according to Embodiment 3;

FIG. 8 is a diagram showing an example of a set of processing instruction sheet in triplicate having inclusion relationships according to Embodiment 3;

FIG. 9 is a diagram showing the relationship of FIGS. 9A and 9B;

FIGS. 9A and 9B are flowcharts showing a process flow for checking originals by use of the scan ticket according to Embodiment 3;

FIG. 10 is a conceptual diagram showing a recheck which is performed on processing instruction sheets ahead of originals by one page according to Embodiment 3;

FIG. 11 is a diagram showing an example of the scan ticket according to the embodiments of the present invention;

FIG. 12 is a conceptual diagram showing an error which occurs in a case where one original is missing according to Embodiment 3; and

FIG. 13 is a conceptual diagram showing an error which occurs in a case where two originals are missing according to Embodiment 3.

### DESCRIPTION OF THE EMBODIMENTS

Descriptions will be hereinbelow provided for the best modes for carrying out the invention by use of the drawings.

### Embodiment 1

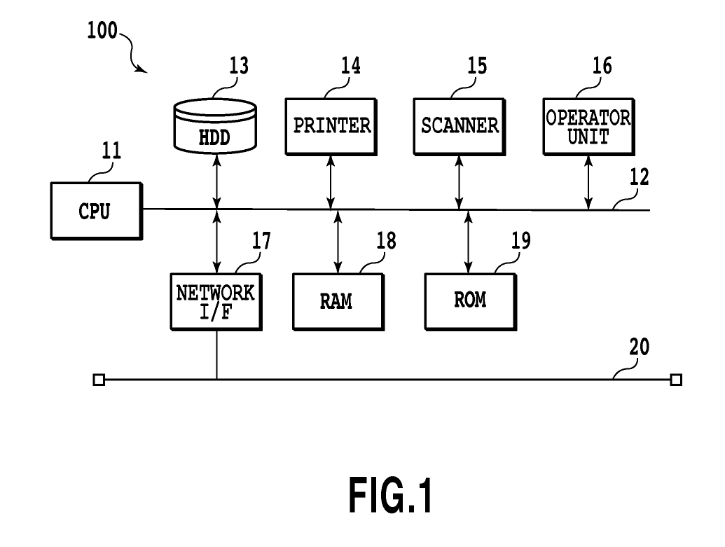

FIG. 1 is a block diagram showing a configuration of an image processing apparatus which is an example of an embodiment of the present invention. A multi-function apparatus including multiple functions such as a copy function and a scanner function is shown as an example of an image processing apparatus 100 according to the embodiment. However, these functions may be achieved through cooperation of multiple apparatuses.

A central processing unit (CPU) 11 loads a program stored in a read-only memory (ROM) 19 to a random access memory (RAM) 18, and thereby controls the operation of the image processing apparatus 100 as a whole. In addition, the CPU 11 makes communications with various components inside the image processing apparatus 100 through a bus 12. An operator unit 16 includes: multiple keys for a user to input instructions; and a display part to display various pieces of information of which the user needs to be informed. A scanner 15 is a reading unit and reads an image on an original, which the user sets on a copyboard, as a color image. Electronic data (image data) thus obtained is stored in a hard disc drive (HDD) 13, the RAM 18 or the like. The HDD 13 is a hard disc drive including a hard disc, and stores various pieces of data which are inputted into the HDD 13. Furthermore, the scanner 15 may be configured to include an original feeding unit, and to read multiple originals set in the original feeding unit while sequentially feeding the multiple originals to the top of the copyboard. A printer 14 which is a printing unit prints an image based on the inputted image data on a recording sheet of paper (a sheet). A network interface I/F 17 connects the image processing apparatus 100 to a network 20, and controls reception of data from an external apparatus on the network and transmission of data to the external apparatus on the network.

Note that, although the embodiment will be described by citing an example in which image data used for a below-described process is inputted through the scanner 15, image data on an original, for example, transmitted from an external apparatus can be similarly processed when inputted through the network I/F 17 as well. Moreover, image data can be similarly processed by a personal computer (PC) or the like connected to the scanner and the printer. In this case, all or part of the program used in the embodiment may be provided to the PC through the network or the like, or may be provided by being stored in a storage medium such as a compact disc read-only memory (CD-ROM). In the embodiment, the scanner 15 corresponds to, for example, first reading unit and second reading unit. In addition, the HDD 13 and the RAM 18 correspond to first storage unit and second storage unit. Furthermore, the CPU 11 corresponds to first check unit, second check unit, control unit, and check result selecting unit.

Next, descriptions will be provided for an example of the original used in the embodiment.

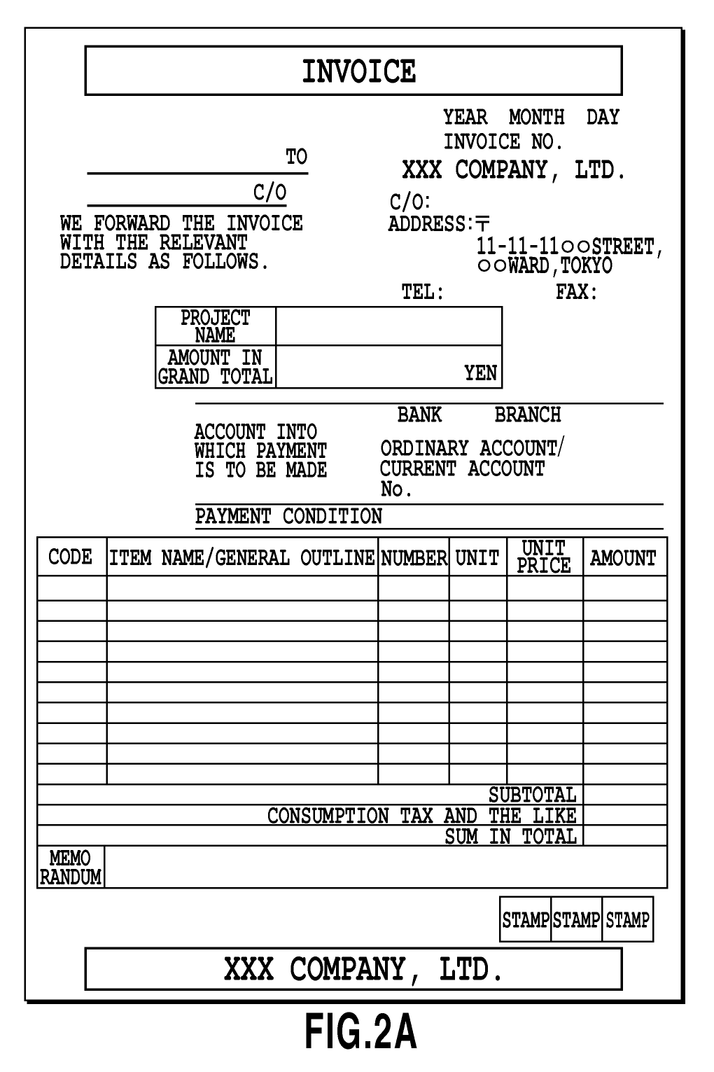

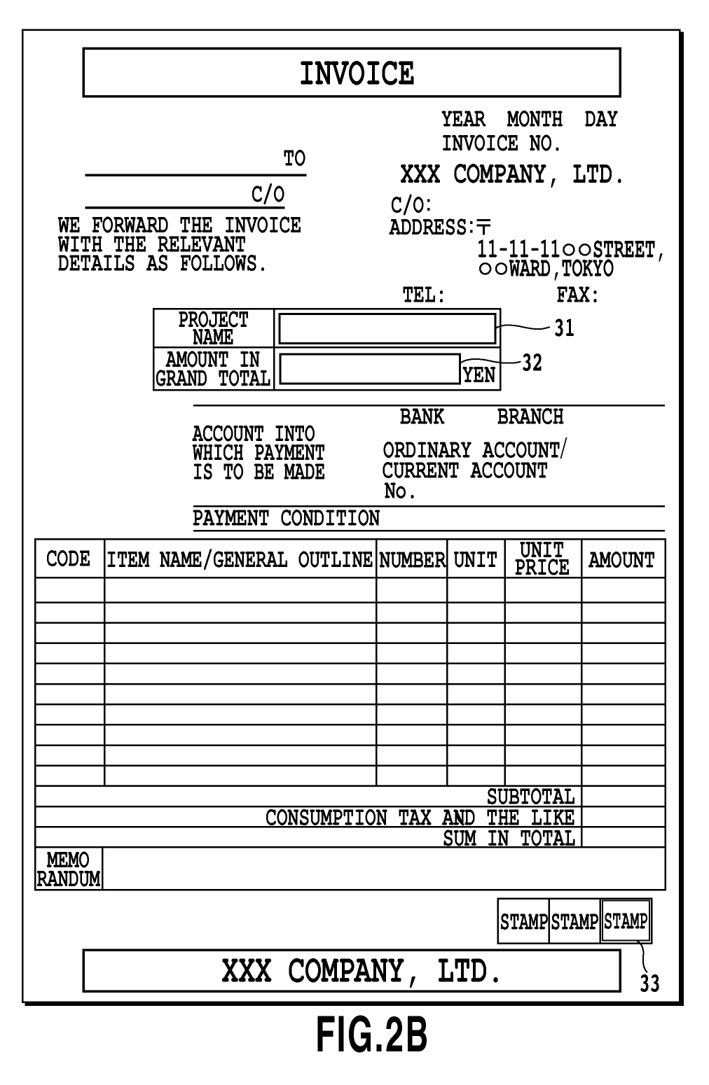

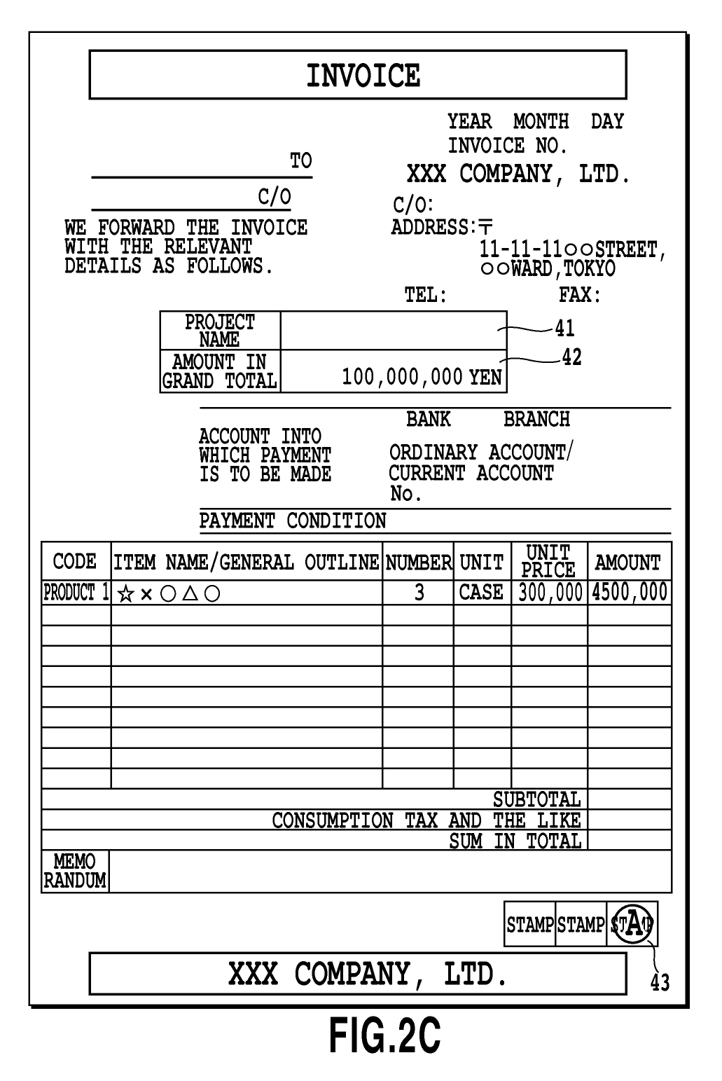

FIG. 2A is a diagram showing an example of a format of the original used in the embodiment. This original is an invoice form in which the user has entered nothing yet (in other words, in which no below-described processing instruction has been added yet). This invoice form includes fields for: a name of a company as a business partner; a person in charge in the business partner; a project name; an amount in grand total; item names; numbers; units; unit prices; amounts; information on a bank to which payment should be wired; subtotal; taxes including consumption tax; memorandum; and regions on which invoice issuers press their stamps. Fields in which the user adds information as entered items when the user intends to officially issue this invoice are those for the project name, item names, numbers, units, unit prices, amounts, stamps of the invoice preparers, and the like.

The embodiment is configured to check whether or not information is added in fields which are specified by the user from the fields in this invoice form, or whether some of the specified fields still remain in blank. Specifically, the embodiment configures the image processing apparatus to check whether or not information is added in fields in the invoice form in which the user expects the information to be added.

FIG. 2B is a diagram showing an example in which arbitrary regions to be checked by the image processing apparatus are added by the user from the items included in the original shown in FIG. 2A by use of a color pen. The original shown in FIG. 2B will be hereinafter referred to as a “processing instruction sheet”. In addition, the instructions added by use of the color pen, which are shown in FIG. 2B, will be referred to as “processing instructions”. The processing instruction sheet is a paper medium having the same format as the original to be checked. Furthermore, the processing instruction sheet includes processing instructions for specifying: regions to be subjected to the check processes; and the contents of the check processes.

Each processing instruction sheet is prepared by the user, who checks the invoice in which predetermined items are entered in the respective fields, by writing the processing instructions in a sheet having the same format as the invoice to be checked. In other words, the invoice form shown in FIG. 2A is turned into the processing instruction sheet once the processing instructions are written in the invoice form. In the embodiment, as closed regions each shaped like a rectangle or the like, regions to be processed are encircled by the user by use of the color pen or the like in order to specify the regions.

Here, descriptions will be provided for a processing instruction (added information) which is written in the invoice form (original). In FIG. 2B, let us assume, for example, that: a region 31 is a region in which a processing instruction is written by use of a blue pen; a region 32 is a region in which another processing instruction is written by use of a green pen; and a region 33 is a region in which yet another processing instruction is written by use of a red pen. Note that: any color other than the colors shown therein may be used. In addition, the number of colors is not limited to the three, and the number of colors may be increased or decreased depending on the contents to be checked. Furthermore, although the pens are used here, the means for writing processing instructions in the corresponding regions are not limited to the pens as long as the means can give colors to the processing instructions.

On the other hand, the user beforehand registers information on colors to be used for the respective processing instructions and the contents of the processes in the RAM 18 by use of the operator unit 16 with the information on the colors associated with the contents of the processes. In the case shown in FIG. 2B, while associated with the blue color, an instruction to check whether or not the corresponding field remains in blank is registered in the RAM 18; while associated with the green color, an instruction to check whether or not information is entered in the corresponding field is registered therein; and while associated with the red color, an instruction to check whether or not a stamp or signature is given to the corresponding field is registered therein. The CPU 11 makes a determination on color components (for example, hues) of the colors thus registered, and causes the associated contents to be stored in the RAM 18. Note that the color registration may be achieved by making the scanner 15 read what has been written in a sheet, instead of using the operator unit 16. Furthermore, the registration may be beforehand made in the image processing apparatus 100, instead of by the user. When following the beforehand-registered contents, the user adds the processing instructions to the original in accordance with the registered colors and the contents of the processes associated with the colors.

As described above, the user beforehand registers the color components used to represent the processing instructions and the corresponding contents of the processes, and subsequently prepares the processing instruction sheet according to the registered contents of the processes. Thus, the image processing apparatus 100 extracts pieces of processing instruction information by use of the processing instruction sheet thus prepared, and recognizes the contents of the processes depending on this extraction result. By recognizing the contents of the processes, the image processing apparatus 100 checks the original to be checked on whether or not information has been entered in a specific region, whether or not another specific region remains in blank, and whether or not a stamp (a mark or the like) has been pressed in yet another specific region. Note that “processing instruction information” means information on a processing instruction which is described in the processing instruction sheet, and is information used for the image processing apparatus 100 to perform the check process.

FIG. 2C is a diagram showing an example of the original to be checked, which is used in the embodiment. The prerequisite for the original to be checked is that the original is based on an original having the same format as FIGS. 2A and 2B show. In the embodiment, the image processing apparatus 100 extracts the pieces of processing instruction information, which represents the processing instructions added by the user as shown in FIG. 2B. Subsequently, on the basis of the extraction result, the image processing apparatus 100 determines that a result of checking the original to be checked is normal when ascertaining that: no entry has been made in a region 41, that is, the region 41 remains in blank; an entry has been made in a region 42; and a stamp has been pressed in a region 43. FIG. 2C is an example of the original which satisfies all the conditions for determining normalcy. For this reason, the result of checking the original is determined as normal (OK). Meanwhile, a result of checking an original which does not satisfy even one of the conditions for determining normalcy is determined as NG. Note that: the contents and regions to be checked are not limited to these; and a check on any other content and a check on any other region may be instructed.

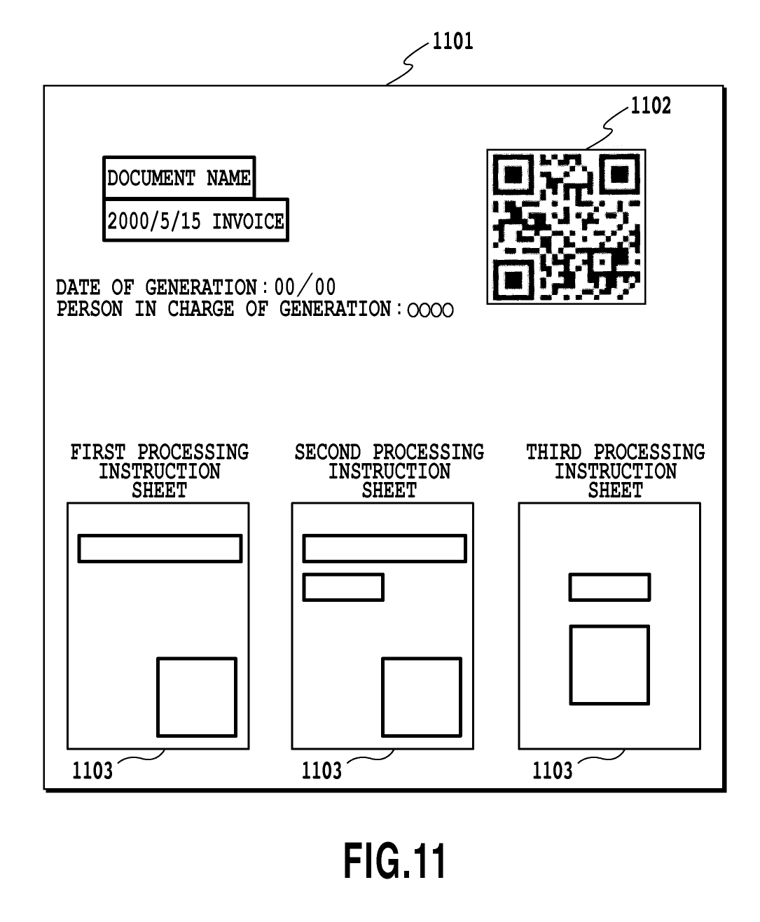

Next, descriptions will be provided for a process of generating a scan ticket for checking contents entered in the original on the basis of the processing instruction sheet as shown in FIG. 2B. In this respect, the “scan ticket” means a paper medium which is in such a format (for example, a two-dimensional bar code such as a quick response (QR) code) that enables the image processing apparatus 100 to recognize the contents of the processing instructions as shown in FIG. 2B, and to recognize the contents of the check made on the original to be checked as shown in FIG. 2C and the like. FIG. 11 is a diagram showing an example of the scan ticket. The scan ticket 1101 shown in FIG. 11 includes: a code 1102 obtained by coding pieces of processing instruction information and the like; and parts 1103 showing regions to be subjected to the processing instructions for making the regions easily visible to the user. The code 1102 includes multiple pieces of processing instruction information for each processing instruction sheet. Furthermore, the code 1102 can include information on a sequential order of processing instruction sheets in association with the processing instruction sheets. As the pieces of processing instruction information, the scan ticket used in the embodiment includes at least: the contents of the instructions recognized by the image processing apparatus 100 from the processing instruction sheet shown in FIG. 2B; and the information on the locations of the regions to which the contents of the instructions are applied. In short, the code 1102 includes: the page numbers (the sequential numbers) of the processing instruction sheets; and the pieces of processing instruction information for each processing instruction sheet.

The checking of the original to be checked is achieved by causing the scanner 15 to read the scan ticket, the CPU 11 to recognize the regions to be processed and the contents of the processes, as well as the image processing apparatus 100 to check the original to be checked.

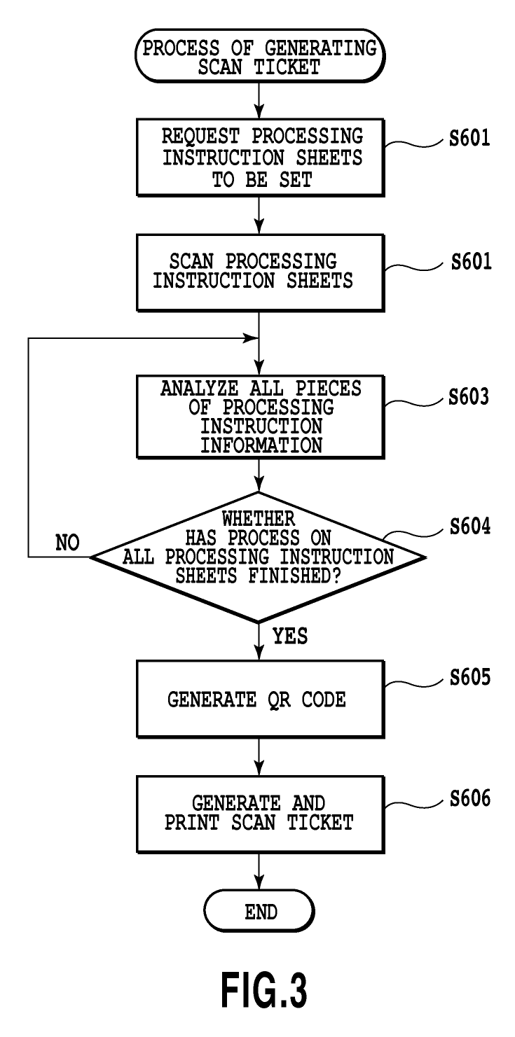

FIG. 3 is a flowchart showing a process flow for generating a scan ticket according to the embodiment. This flowchart shows the process flow in which the CPU 11 loads the program stored in the ROM 19 to the RAM 18 and executes the program.

This flow starts once the user issues an instruction to generate the scan ticket through the operator unit 16.

In step S601, the CPU 11 causes the operator unit 16 to display a message requesting a user to set a set of processing instruction sheets on the scanner 15. Once the CPU 11 detects through the operator unit 16 that, in response to this, the user presses an OK bottom after setting the originals, the CPU 11 causes the scanner 15 to read the set of processing instruction sheets in step S602. Image data obtained in this step is stored in the RAM 18.

Subsequently, in step S603, the analysis/recognition process is performed on pieces of processing instruction information from the image data inputted through the scanner 15. In this respect, first of all, the CPU 11 analyzes where instruction colors representing processing instructions are located in the original, and recognizes the colors in the locations. Thereby, the CPU 11 identifies the location of an object region for each color. The location identified in this event is sufficient to discriminate how large a region to be processed exists in what location in the original. The location is identified, for example, by use of a coordinate system. Subsequently, the location identified in this event, the content of the corresponding process, and what processing instruction sheet occupies in order (the page number of the processing instruction sheet) are stored in the RAM 18.

Thereafter, in step S604, the CPU 11 determines whether or not all the processing instruction sheets read in step S602 have finished being processed. In a case where all the processing instruction sheets have finished, the flow proceeds to step S605. In a case where all the processing instruction sheets have not finished yet, the flow proceeds to step S603.

In step S605, the CPU 11 codes the contents of the analysis. Coding the contents of the analysis means coding a result obtained by the analysis by use of, for example, a two-dimensional code (for example, a QR code). The contents (analysis result) coded in the embodiment include: regions whose processes are instructed in each page; and the contents of the processes applied to the regions. In this respect, although descriptions have been provided by citing the two-dimensional code, the contents may be coded by use of any other method. The method of coding the contents is not limited to this two-dimensional code as long as the image processing apparatus 100 can analyze and recognize the coded contents. In step S606, the CPU 11 causes the printer 14 to output and print the coded contents which have been generated in step S605, as an image, onto a recording sheet of paper.

The original to be checked can be checked by use of the scan ticket printed in step S606. However, the check process, which will be described later, may be performed by use of the contents of the read processing instruction sheets with the scan ticket generating process skipped. In this case, the image processing apparatus 100 is configured to recognize the contents of the processes and the like from the read processing instruction sheets when checking the original to be checked. Otherwise, the check may be performed by using the pieces of processing instruction information for each page, which have been obtained by reading the set of processing instruction sheets and stored in the RAM 18 or the HDD 13 beforehand. In this case, the user may be asked, through the operator unit 16, whether or not to perform the check by use of the stored pieces of information.

The following advantages are brought about by the check process performed on the original using the outputted scan ticket obtained by: coding the pieces of processing instruction information for each processing instruction sheet, which are obtained by reading the image data; and outputting the pieces of information onto the paper medium as the scan ticket. Specifically, in a case where, for example, the rectangle or the like handwritten by the user for specifying a processing instruction is out of shape or smeared, this can be coded by the image processing apparatus 100 after corrected into right location information. For this reason, in this case, the scan ticket is generated as a paper medium which includes the code representing the properly-corrected information. In addition, because the image processing apparatus 100 performs a process for reflecting the contents of the processing instructions, the correctness of the contents of the processing instructions (use of no wrong colors, and the like) can be proven. Moreover, as an example of use of the image processing apparatus 100 by the user for actually performing the check, the following method is conceivable. Specifically, one may consider a case in which: originals to be checked are set in the original feeding unit with a scan ticket put on top of the originals to be checked; and the originals to be checked are read and checked while sequentially fed to the top of the copyboard. The scan ticket is a sheet of paper on which the contents of the multiple processing instruction sheets are summarized. For this reason, when a set of multiple originals are checked, it is never that the processing instruction sheets themselves are sequentially misplaced. Moreover, reusability is enhanced in a case where the check is performed again under the same condition; for example, a case where the check is performed by another image processing apparatus under the same condition. As described above, the use of the scan ticket offers the various advantages, although the scan ticket does not have to be used in Embodiment 1 and various embodiments which will be described later. In the following examples, cases in which the scan ticket is used will be described.

Next, detailed descriptions will be provided for a procedure for checking the originals in response to the extracted pieces of processing instruction information by use of the scan check generated in the above-described manner. Note that, as described above, the two-dimensional code and the like of the scan ticket include: the coded page numbers (sequential numbers) assigned to the processing instruction sheets when the processing instruction sheets are read; and the coded pieces of processing instruction information for each processing instruction sheet. For this reason, the analysis of the two-dimensional code means nothing more than reconstructing the above-mentioned pieces of information, and does not necessarily mean reconstructing the processing instruction sheet itself. Nevertheless, to make the present invention easily understood, the following descriptions will be provided on the assumption that: as information, the processing instruction sheet itself is included in the scan ticket; and the processing instruction sheet itself is reconstructed when the scan ticket is read and analyzed.

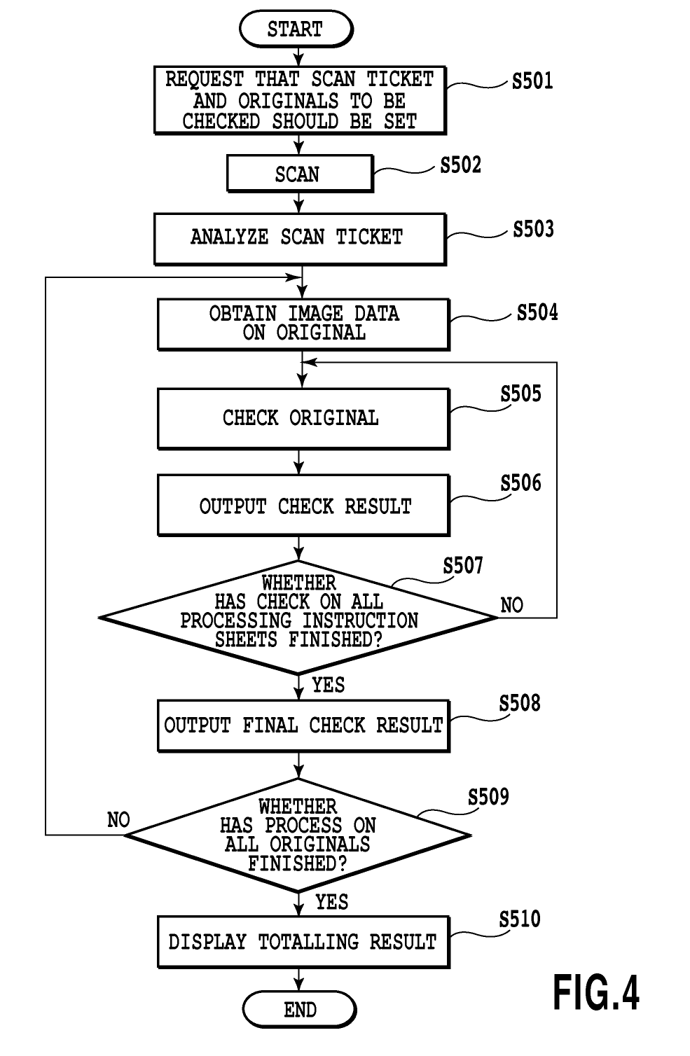

FIG. 4 is a flowchart showing a process flow for checking originals to be checked by use of the scan ticket. This flowchart shows the process flow in which the CPU 11 loads the program stored in the ROM 19 to the RAM 18 and executes the program.

The flow starts once the user issues an instruction to check the originals to be checked through the operator unit 16. Once this flow starts, the CPU 11 causes the operator unit 16 to display a message requesting that the scan ticket, which has been printed in step S606, should be placed as the first sheet and then the originals to be checked should be set in pile in the original feeding unit (in step S501). Subsequently, once an instruction to read the originals is issued by, for example, pressing the OK bottom in the operator unit 16 after the originals are set therein, the flow proceeds to step S502, where the CPU 11 starts the reading of the originals by the scanner 15 while sequentially feeding the originals set in the original feeding unit to the scanner. In this event, first of all, the CPU 11 feeds the scan ticket which is the first sheet among the originals set in the original feeding unit, and causes the scan ticket to be read by the scanner 15. Thereafter, the CPU 11 causes the scanner 15 to sequentially read the originals to be checked which have been set in pile under the scan ticket. Note that multiple originals to be checked can be set in pile. Furthermore, a number of originals can be set in the original feeding unit by dividing the originals into multiple piles, when it is specified through the operator unit 16 that they should be treated as serial originals.

In step S503, an analysis/recognition process is performed on the image of the first original read in step S502, namely, the scan ticket. In this respect, out of the read scan ticket, the two-dimensional code and the like are analyzed. Thereby, the recognition is performed on: regions (locations) which are objects of the processing instructions; the contents of the processes; and the page numbers of the processing instruction sheets which are included as information in the scan ticket. The recognition of the page numbers of the processing instruction sheets can be achieved by making the CPU 11 assign the page numbers to the processing instruction sheets in the order that the processing instruction sheets are beforehand read by the scanner 15. Otherwise, in a case where the processing instruction sheets are provided with fields in which the corresponding page numbers are entered, the page numbers can be recognized by: recognizing a processing instruction for specifying a page number (a rectangular region encircled in a predetermined color); and using an optical character reader (OCR) on the region. A result of the recognition in step S503 is stored in the RAM 18. In this embodiment, the page numbers of the processing instruction sheets, which are included in the scan ticket, do not have to be recognized as a result of the analysis process performed on the image of the scan ticket. In Embodiments 2 and 3 which will be described later, however, the page numbers have to be recognized.

Thereafter, in step S504, the CPU 11 sequentially reads pieces of image data to be checked, which are stored in the HDD 13. The pieces of image data to be checked are those which have been read together with the scan ticket by the scanner 15. Instead, however, the pieces of image data to be used here may be pieces of image data to be checked which have been read beforehand alone by the scanner 15 and stored in the HDD 13. Otherwise, the pieces of image data to be checked may be read from an external apparatus through the network I/F.

Subsequently, in step S505, for each of the processing instruction sheets included in the scan ticket, the CPU 11 performs an analysis/determination process on the pieces of image data, which have been read in step S504 from the original to be checked, by use of the recognition result stored in the RAM 18. For example, in the case shown in FIG. 2C, if the region 41 remains in blank, the region 41 is determined as normal; if an entry has been made in the region 42, the region 42 is determined as normal; and if a stamp or signature has been given in the region 43, the region 43 is determined as normal. These determinations are achieved as follows. For example, when a binary process is performed on the image of the region 41 by use of a predetermined threshold value, if the percentage of the number of white pixels (each representing no portion of the image) occupying the area of the region 41 is 80% or more, the region 41 is determined as remaining in blank. In addition, when a binary process is performed on the image of the region 42 by use of a predetermined threshold value, if the percentage of the number of black pixels (each representing a portion of the image) occupying the area of the region 42 is 20% or more, it is determined that an entry has been made in the region 42. With regard to the region 43, when a binary process is performed on the red color or a hue close to the red color which is extracted from the image thereof, if the percentage of existing pixels is 20% or more, it is determined that a stamp or signature has been given to the region 43. The above-mentioned numerical values representing the percentages are just examples. Other numerical values may be used instead. In addition, other determination methods may be used instead.

Afterward, in step S506, the CPU 11 stores determination results, which have been obtained through the check, in the RAM 18. In this respect, an OK determination result is stored therein if the determination results of all the regions to be processed in the single original to be checked are normal, or a NG determination result is stored if even one of the regions in the original is recognized as abnormal. For each of the processing instruction sheets included in the scan ticket, the determination result is stored. Note that a score value (check score) as which each value is expressed with respect to the corresponding one of the above-mentioned threshold values may be instead stored as a determination result. For example, in the case of the region 42 in FIG. 2C, if black pixels are included more than necessary, the following reasons are conceivable: characters are likely to be too bold; the region 42 is likely to be smeared; and so forth. With this taken into consideration, if the black pixels are included more than necessary, a lower score value may be assigned to the region 42 on the assumption that, although an entry has been made in the region 42, the characters are hard to discriminate. Specifically, when the percentage of the number of black pixels occupying the area is not smaller than 20% but smaller than 50%, the highest score of 5 is assigned; when the percentage is not smaller than 50% but smaller than 70%, a score of 3 is assigned; and when the percentage is not smaller than 70%, a score of 1 is assigned. Furthermore, when the percentage of the number of black pixels occupying the area is smaller than 20%, a score of 0 (zero) is assigned. It is possible to perform the determination process by assigning such check scores to the respective items to be checked in each page, and thus to calculate the determination result of each page by use of an average score value of the scores or a value representing a total of the scores. In other words, it is possible to calculate a check score for each of the pieces of processing instruction information. In addition, although each determination result is either “OK” or “NG” as described above, the result can be expressed as a binary value. Thus, such a result also corresponds to a “check core”, which has been described.

Afterward, in step S507, the CPU 11 determines whether or not the check has finished being performed on the pieces of image data, which have been read in step S504, for all the multiple processing instruction sheets included in the scan ticket. In a case where the check has finished, the flow proceeds to step S508. In a case where the check has not finished yet, a processing instruction sheet having the next page number is set as the processing instruction sheet for the check, and the flow proceeds to step S505. Through steps S505 to S507, for each original to be checked, the check is performed by applying all the multiple processing instruction sheets included in the scan ticket. Thereby, a wrong processing instruction sheet due to a missing original(s) or the like is inhibited from being applied, and the reliability of the check result is accordingly inhibited from deteriorating.

In step S508, the CPU 11 determines a final check result on the basis of the results of the checks using the processing instruction sheets, which are stored in the RAM 18, and stores the final check result in the RAM 18. In this respect, the method of determining the final check result is as follows. For example, the final check result is determined as OK in a case where even one of the results of the checks using the processing instruction sheets included in the scan ticket is OK; and the final check result is determined as NG in a case where all the results of the checks using the processing instruction sheets are NG.

Subsequently, in step S509, the CPU 11 determines whether or not the process has finished being performed on all the pieces of image data on the originals to be checked, which have been read in step S502. In a case where the process has finished, the flow proceeds to step S510. Meanwhile, in a case where the process has not finished yet, the flow proceeds to step S504.

Instep S510, the CPU 11 totalizes the check results of all the originals, which have been accumulated in the RAM 18, and causes the operator unit 16 to display the total result. Totalizing the results means collecting, for example, the total number of originals to be checked which have been checked, the total number of regions determined as NG, the page numbers of the originals each including a region (s) determined as NG, and the like. The page numbers are assigned as follows. Page 1 is assigned to the first one of the originals to be checked, excluding the scan ticket, and the remaining page numbers ascend in order that the originals to be checked have been read by the scanner 15 (the order that the originals to be checked have been fed from the original feeding unit). Pieces of information other than the pieces of information shown here may be further totalized if they can be identified from the pieces of information stored in the RAM 18. Note that, although the descriptions have been hereinabove provided on the assumption that the pieces of information are accumulated in the RAM 18, the same processes can be performed even if the accumulation is made in the HDD 13 instead.

As described above, when the check is performed by use of the pieces of information on the multiple processing instructions by, for example, reading the scan ticket, Embodiment 1 makes it possible to inhibit the reliability of the check result from deteriorating due to mixed inclusion of: originals arranged in a wrong sequential order; and originals short of the expected number. Particularly, in a case where a set of multiple originals are arranged irrespective of their sequential order, it is possible to inhibit the reliability of the check result from deteriorating even if errors (missing pages, and the like) occur other than the item errors (missing entries, and the like) which are originally intended to be checked.

### Embodiment 2

Embodiment 1 has been described as the example in which the multiple originals can be dealt with no matter what order the originals are arranged in. In contrast, this embodiment will be described as an example which is based on the arrangement of a set of multiple originals in a predetermined sequential order. In this embodiment, a check is performed by applying a set of processing instruction sheets for multiple sets each consisting of multiple originals arranged in the predetermined order. Descriptions will be provided for a method in which, in a case where a check result agrees with a particular pattern, an error stemming from arrangement of originals in a wrong sequential order or a missing original (s) is inhibited by performing the check by applying different processing instruction sheets. It should be noted that, in this embodiment, the “case where a check result agrees with a particular pattern” is described as a “case where NG occurs as a check result”. Specifically, in this embodiment, in a case where the check result is NG, the check is performed by applying different processing instruction sheets, because a page (s) is likely to be missing in addition to the likelihood of a missing entry as an error factor.

In this embodiment, parts which are the same as those of Embodiment 1 will be denoted by the same reference numerals, and descriptions for such parts will be omitted. Descriptions will be provided for only parts which are different from those of Embodiment 1. Furthermore, like Embodiment 1, this embodiment will be described as the example of using a scan ticket obtained by summarizing pieces of information on multiple processing instruction sheets. Nevertheless, a process which is the same as the below-described process can be performed by: beforehand storing pieces of information on multiple processing instruction sheets in the RAM 18 or the like; and applying the thus-stored pieces of information when the originals are read, as described in Embodiment 1.

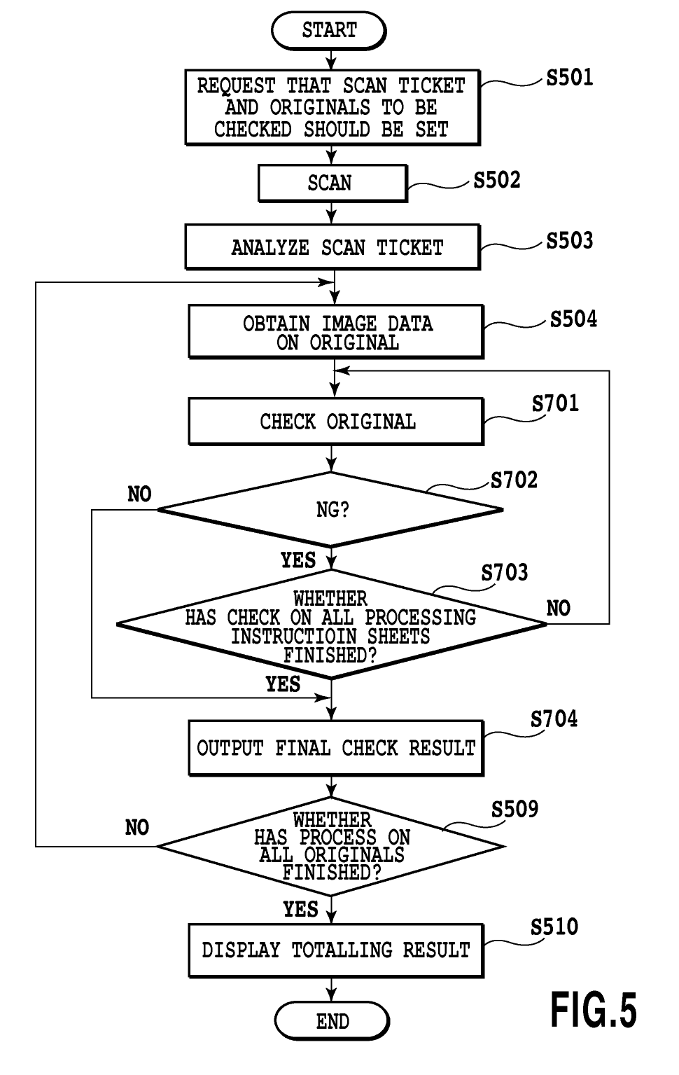

FIG. 5 is a flowchart showing a process flow for performing a check on originals to be checked by use of a scan ticket in this embodiment. This flowchart shows the process flow in which the CPU 11 loads the program stored in the ROM 19 to the RAM 18 and executes the program.

Steps S501 to S504 are the same processes as those shown in FIG. 4. Note that, in this embodiment, used are the page numbers of the processing instruction sheets which are included in a scan ticket and are obtained as a result of the analysis performed instep S503. Furthermore, this embodiment will be described as the example in which a scan ticket including information on a set of three processing instruction sheets is read. Nevertheless, as a matter of course, a scan ticket further including pieces of information on any other number of processing instruction sheets may be used.

In step S701, for each of the processing instruction sheets included in the scan ticket, the CPU 11 performs an analysis/recognition process on the pieces of image data, which have been read in step S504, by use of the recognition result which is obtained by analyzing the scan ticket and stored in the RAM 18. On this occasion, the processing instruction sheets are sequentially applied in the order of being read by use of the scanner 15 in step S502. For example, in a case where the page number of a processing instruction sheet which is applied to an original read in the preceding time (i.e., read one sheet ahead) is Page 1, a processing instruction sheet corresponding to Page 2 is applied to an original read in this time. Similarly, in a case where the processing instruction sheet corresponding to Page 2 is applied to the original read in the preceding time (i.e., read one sheet ahead), a processing instruction sheet corresponding to Page 3 is applied to an original read in this time. Furthermore, in a case where the page number of the processing instruction sheet applied to the original read in the preceding time is Page 3, the processing instruction sheet corresponding to Page 1 is applied to an original read in this time, because all the processing instruction sheets have finished being applied in one round. Note that the processing instruction sheet corresponding to Page 1 is applied to the first original. The contents of the analysis/recognition process are the same as those in step S505 in FIG. 4.

Subsequently, in step S702, the CPU 11 determines whether or not the check result in step S701 is NG. If the check result is NG, the flow proceeds to step S703. If the check result is OK, the flow proceeds to step S704. In this respect, the check result is determined as OK if all the results of the recognitions performed on the single original to be checked are normal, and is determined as NG if even one result is not recognized as normal.

Thereafter, in step S703, the CPU 11 determines whether or not the check has finished being performed on the pieces of image data, which have been read in step S504, by applying all the multiple processing instruction sheets included in the scan ticket. In a case where the check has finished, the flow proceeds to step S704. Meanwhile, in a case where the check has not finished yet, the flow proceeds to step S701. Specifically, in processes of steps S701 to S704, only when all the check results are NG, a check process is performed by applying the different processing instruction sheets; and when even one of the check results is OK, the check process is quitted on that occasion.

In step S704, the CPU 11 compares the results of the checks performed on the pieces of image data stored in the RAM 18, which have been read in step S504 for the processing instruction sheets. Then, the best result is stored in the RAM 18 as a final check result of the pieces of image data which have been read in step S504. For example, from check scores calculated as a result of the sequential application of pieces of processing instruction information which have not been applied yet, the result of the check performed on the pieces of image data is selected. In this respect, the final check result is determined as OK in a case where even one of the check results is OK, and the final check result is determined as NG in a case where all the check results are NG.

Steps S509 and S510 are the same processes as those shown in FIG. 4.

As described above, when the check is performed on a set of multiple originals, Embodiment 2 makes it possible to inhibit the reliability of the check result from deteriorating due to mixed inclusion of: originals arranged in a wrong sequential order; and originals short of the expected number. Furthermore, in Embodiment 2, the check process is performed by additionally applying processing instruction sheets which have not been applied yet only in the case where a check result is NG. Thus, Embodiment 2 can make the amount of the process smaller than a case where the check process is performed by applying all the processing instruction sheets to all the originals.

In this embodiment, the check is performed by applying the different processing instruction sheets in the “case where a check result agrees with a particular pattern” which is described as the “case where NG occurs as a check result”. However, the check may be performed by applying the different processing instruction sheets in other cases as well. For example, the check may be performed by applying a different scan ticket in a case such as a “case where NG repeatedly occurs a certain number of times” and a “case where NG repeatedly occurs multiple times that correspond to the number of originals”.

The check may be performed in a scheme in which: multiple patterns are beforehand stored in the ROM 19; the user is requested to select one pattern from the multiple patterns; and the different processing instruction sheets are applied when the selected pattern appears.

### Embodiment 3

Like Embodiment 2, this embodiment is based on the arrangement of a set of multiple originals in a predetermined sequential order.

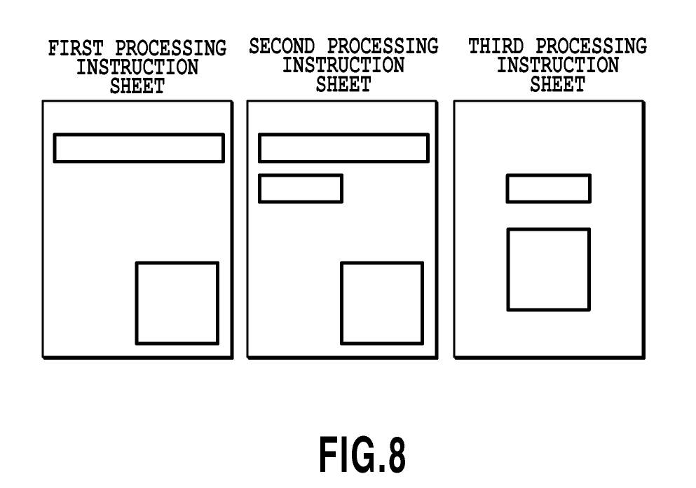

When there is a set of multiple processing instruction sheets, an inclusion relationship may exist among the processing instruction sheets. An example of such as a relationship is that the first processing instruction sheet includes all the processing instructions of the second processing instruction sheet. For example, in a case shown in FIG. 8, all the instruction contents of the first processing instruction sheet are included in the second processing instruction sheet. Such a case is termed as a case where an “inclusion relationship exists” in this embodiment.

In a case where a check is performed by use of a scan ticket generated from a set of multiple processing instruction sheets among which an inclusion relationship exists, if wrong processing instruction sheets are applied due to an error such as a missing original(s), an OK determination may occur depending on the inclusion relationship although an NG determination should occur.

In this case, the error such as a missing original (s) cannot be detected by a method in which all the processing instruction sheets included in the scan ticket are applied to one original to be checked. In this embodiment, descriptions will be provided for a method in which: when a scan ticket is generated, a check result pattern which is likely to occur due to a missing original(s) is predicted beforehand; and an error(s) such as a missing original(s) is detected by use of the pattern.

In this embodiment, parts which are the same as those of the foregoing embodiments will be denoted by the same reference numerals, and descriptions for such parts will be omitted. Descriptions will be provided for only parts which are different from those of the foregoing embodiments.

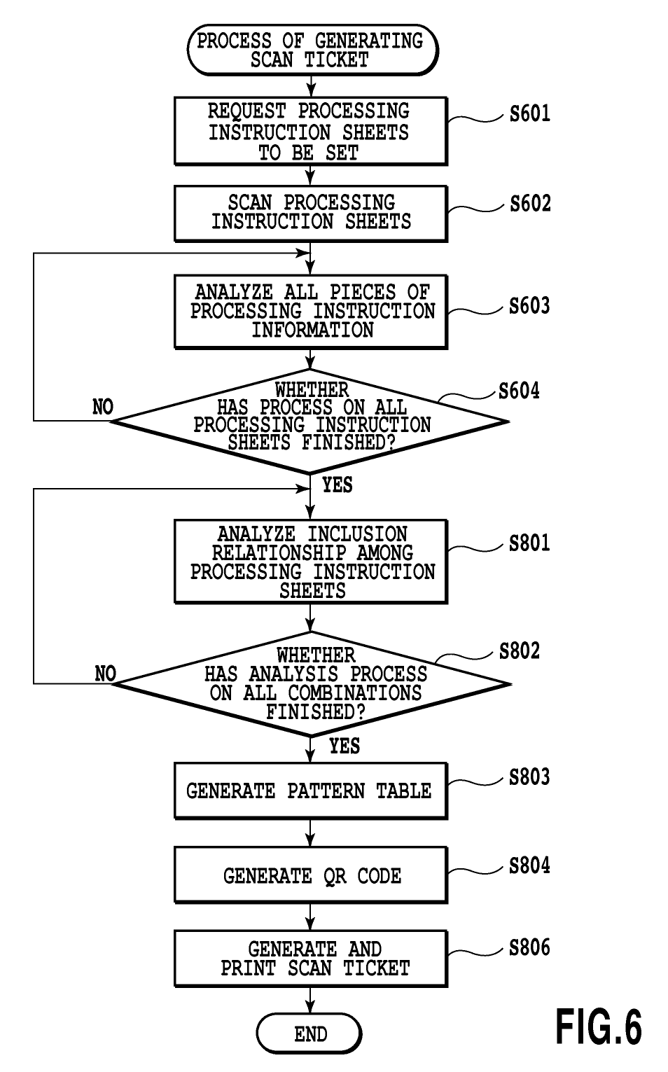

FIG. 6 is a flow chart showing a process flow for generating a scan ticket according to this embodiment. This flow chart shows the process flow in which the CPU 11 loads the program stored in the ROM 19 to the RAM 18 and executes the program. In this embodiment, the scan ticket is generated by coding various pieces of information which include check result patterns which, as described above, are likely to occur due to a missing original(s).

Once an instruction to generate a scan ticket is issued by the user through the operator unit 16, this flow starts.

Steps S601 to S604 are the same processes as those shown in FIG. 3.

In step 801, the CPU 11 analyzes an inclusion relationship in processing instruction information among multiple processing instruction sheets stored in the RAM 18, and stores, in the RAM 18, the existence or absence of the inclusion relationship and the page numbers of the processing instruction sheets on which the analysis is performed. For instance, in a case where an inclusion relationship between the first and second processing instruction sheets is analyzed, if the second processing instruction sheet includes all the processing instructions (regions to be processed and contents of the processes) which the first processing instruction sheet has, the first processing instruction sheet is determined as being covered by the second processing instruction sheet. A determination of whether or not all the processing instructions are included is made as follows. For example, if 80% of all the regions of one processing instruction sheet are included in the other processing instruction sheet, the same regions whose processes are instructed are determined as being included.

Subsequently, in step S802, the CPU 11 determines whether or not the process of the inclusion relationship analysis has finished being performed on all the combinations of the processing instruction sheets stored in the RAM 18 in step S603. In a case where the analysis process has finished, the flow proceeds to step S803. Meanwhile, in a case where the analysis process has not finished, the flow proceeds to step S801.

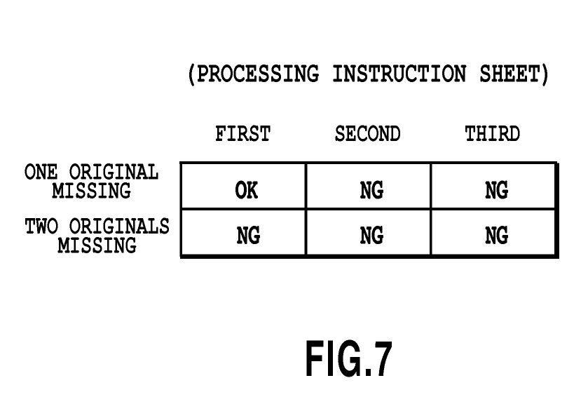

In step S803, for each error that is likely to occur, the CPU 11 predicts a check result (OK or NG) when the error takes place by use of inclusion relationship information indicating inclusion relationships in processing instruction information among the multiple processing instruction sheets stored in the RAM 18. For example, the CPU 11 predicts check results which are likely to occur in cases such as one missing original and two missing originals. This process of predicting the check results is performed on the assumption that the contents described in the originals to be checked are correct. In other words, on the assumption that predicted check results are OK if the processing instruction sheets are rightly applied with no original missing, check results are predicted depending on types of missing originals. Subsequently, as a check result pattern table, the check results thus predicted are stored in the RAM 18. In this respect, for example, in a case where there is a set of processing instruction sheet in triplicate, the errors that are likely to occur include one missing original, two missing originals, misplacement between first and second originals, misplacement between second and third originals, misplacement between third and first originals, and so forth. In this embodiment, as the errors that are likely to occur, missing of an original (s) is taken into consideration to simplify descriptions. Furthermore, the check result pattern table is represented as an M×N two-dimensional table where M is the number of errors that may occur; and N is the number of originals (i.e., the number of processing instruction sheets is N). In this manner, the check result pattern table is defined according to an error that is likely to occur in each set of multiple originals. Either of OK or NG which are the predicted check results is stored in each element of the table. FIG. 7 shows an example of a pattern table in which the number of errors that may occur is two and the number of originals is three.

Descriptions will be hereinbelow provided for an example of check result prediction.

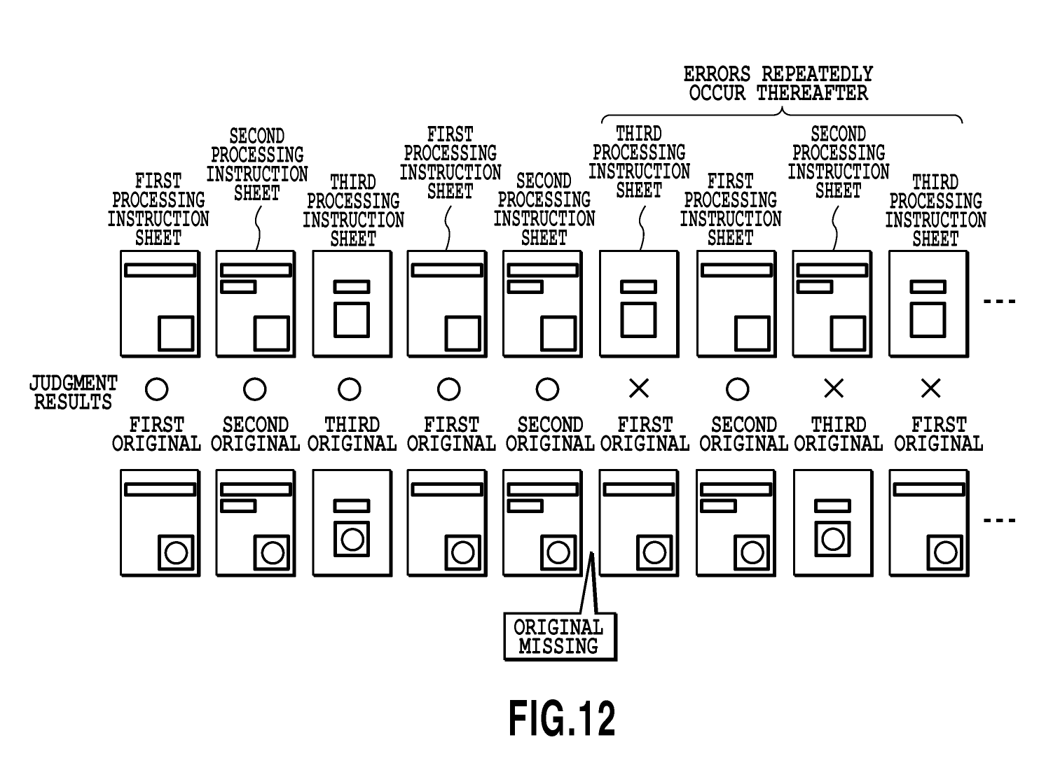

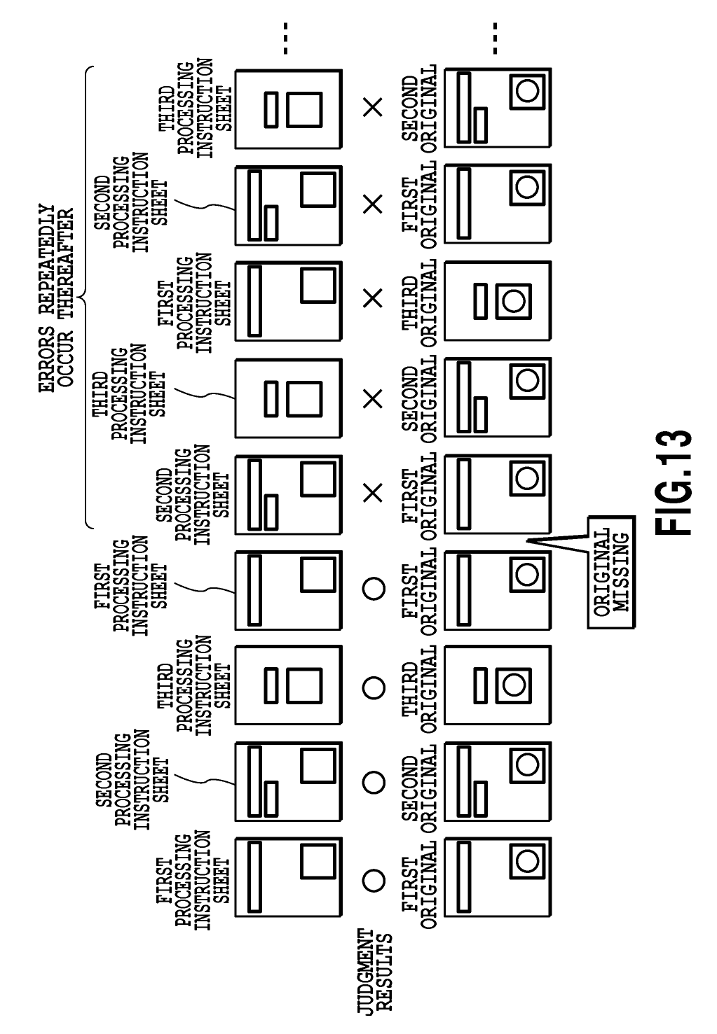

In a case where a set of originals to be checked is in triplicate, the number of processing instruction sheets in a set is three as well. Let us assume that in a set of processing instruction sheet in triplicate, the second sheet covers the first sheet while the third sheet has no inclusion relationship with the first and second sheets. FIG. 8 shows an example of processing instruction sheets in this case. In steps S801 and S802, the CPU 11 makes a determination on these inclusion relationships, and stores the determination result in the RAM 18. In a case where one original is missing, the first processing instruction sheet is applied to the second original, the second processing instruction sheet is applied to the third original, and the third processing instruction sheet is applied to the first original. FIG. 12 conceptually shows determination results which are likely to occur in a case where one original is missing. Based on this, in step S803 of FIG. 6, the CPU 11 predicts check results which are likely to occur in the case where one original is missing as follows. The check result of the first original is predicted as OK, the check result of the second original is predicted as NG, and the check result of the third original is predicted as NG. Furthermore, in a case where two originals are missing, as shown in FIG. 13, the first processing instruction sheet is applied to the third original, the second processing instruction sheet is applied to the first original, and the third processing instruction sheet is applied to the second original. Based on this, in step S803, the CPU 11 predicts check results which are likely to occur in the case where two originals are missing as follows. The check result of the first original is predicted as NG, the check result of the second original is predicted as NG, and the check result of the third original is predicted as NG. In this example, as a 2×3 two-dimensional table, a check result pattern table as shown in FIG. 7 is made because the number of errors that are likely to occur is two and the number of originals is three.

In step S804, the CPU 11 codes the analysis contents of the read processing instruction sheets and the pattern table. Step S806 is the same process as that shown in FIG. 3.

Next, detailed descriptions will be provided for a procedure for checking originals by use of a scan ticket generated as described above.

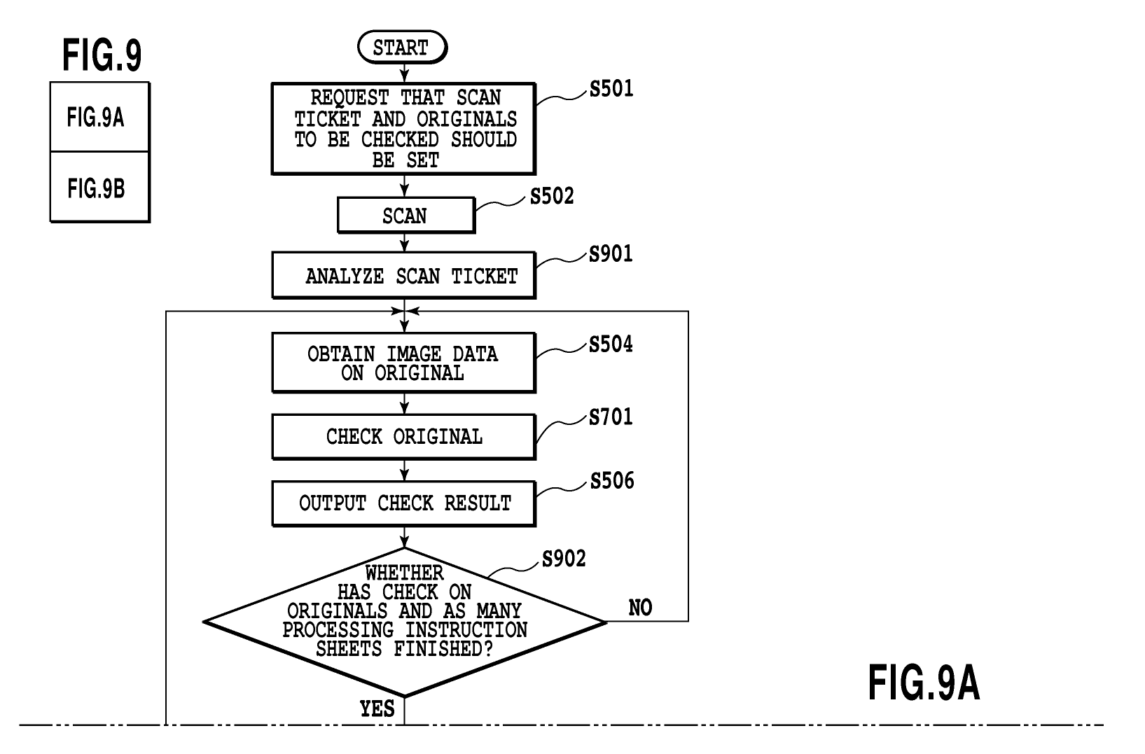

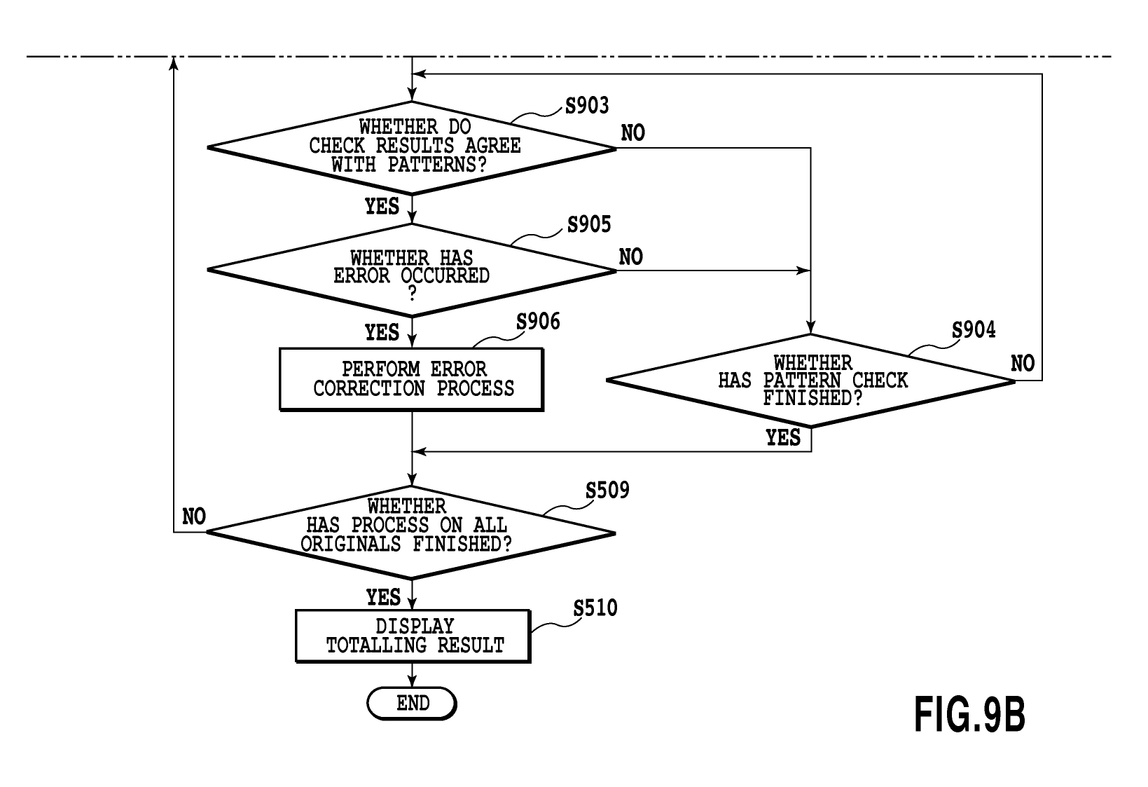

FIGS. 9A and 9B are flowcharts showing a process flow for checking originals to be checked by use of a scan ticket. This flowchart shows the process flow in which the CPU 11 loads the program stored in the ROM 19 to the RAM 18 and executes the program.

Steps S501 and S502 are respectively a step of setting the scan ticket and the originals to be checked, and a step of reading them by use of the scanner 15, like those shown in FIG. 4.

In step S901, an analysis/recognition process is performed on the image of the first one of the originals having been read in step S502, namely, the image of the scan ticket. In this respect, the analysis is performed on the two-dimensional code and the like printed on the read scan ticket, and the recognition is performed on: regions (locations) which are objects of the processing instructions; the contents of the processes; the page numbers of the processing instruction sheets which are included in the scan ticket; and the check result pattern table. The recognition result is stored in the RAM 18.

Step S504 is the same process as that shown in FIG. 4; step S701 is the same process as that shown in FIG. 5; and step S506 is the same process as that shown in FIG. 4.

Subsequently, in step S902, the CPU 11 determines whether or not the check has finished being performed on the originals and as many processing instruction sheets (for example, three processing instruction sheets if the number of originals in a set is three). In a case where the check has finished, the flow proceeds to step S903. Meanwhile, in a case where the process has not finished yet, the flow proceeds to step S504. The number of originals may be beforehand inputted into the image processing apparatus by the user. Otherwise, the number of originals may be based on the number of processing instruction sheets included in the scan ticket. In this respect, if the flow proceeds to step S903, the count of the number (0 to 3 if the number of originals in a set is three) of processing instruction sheets to be determined in this step is reset at zero.

Thereafter, in step S903, the CPU 11 determines whether or not the results of the checks performed on the originals and the as many processing instruction sheets agree with any of the patterns stored in the pattern table having been read from the scan ticket in step S901. In other words, the CPU 11 determines whether or not any pattern indicating the error of a missing original (s) appears among the results of the checks performed on the originals and the as many processing instruction sheets. In a case where agreement is recognized, the flow proceeds to step S905. In a case where no agreement is recognized, the process proceeds to step S904. In a case where there are multiple patterns stored in the pattern table, the pattern agreement determination is performed in order that the multiple patterns have been stored in the pattern table. For example, in the case of the pattern table shown in FIG. 7, the determination is performed on agreements with the pattern that one original is missing first.

In step S904, the CPU 11 determines whether or not the check has finished being performed on agreements with all the patterns stored in the pattern table. In a case where the check has finished, the flow proceeds to step S509. Meanwhile, in a case where the check has not finished yet, the flow proceeds to step S903, where the check is repeatedly performed on agreement with the next pattern.

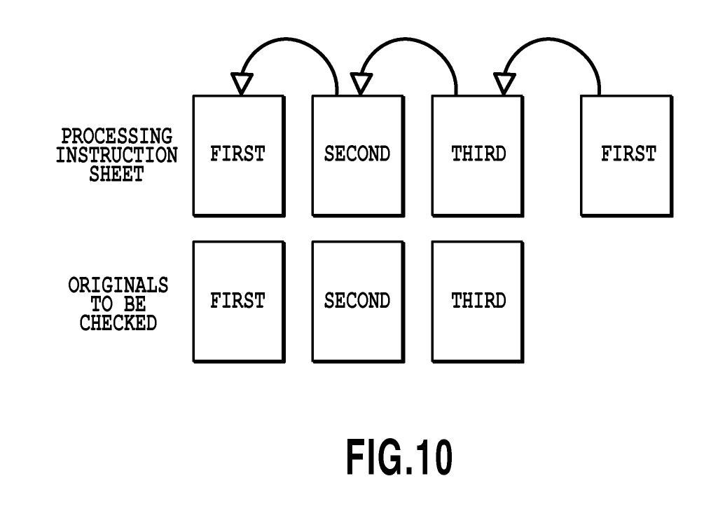

In step S905, the CPU 11 determines whether or not an error has actually occurred. In a case where an error has occurred, the flow proceeds to step S906. Meanwhile, in a case where no error has occurred, the flow proceeds to step S904. In this respect, the process of checking the occurrence of an error means a process of judging whether or not an error corresponding to the pattern, the agreement with which has been recognized in step S903, has actually occurred. For example, if in step S903, a check result agrees with the pattern which is likely to occur in the case where one original is missing, a recheck is performed by advancing the as many processing instruction sheets, which are applied to the originals to be currently checked, by one page (see FIG. 10). In other words, the check is performed by shifting the correspondence between the originals and the processing instruction sheets. On this occasion, if all the check results are OK (i.e., if the error disappears), an error of one missing original is determined as having occurred. If not, the error of one missing original is determined as not having occurred.

In step S906, the CPU 11 performs an error correction process. For example, in the case where the error of one original missing has occurred, the order of arrangement of the processing instruction sheets is changed by advancing the processing instruction sheets to be applied to the originals by one page, as shown in FIG. 10, so that the check can be performed for each subsequent set of originals.

Note that, for example, in a case where one original is missing as shown in FIG. 12, the check results which agree with the pattern stored in the pattern table are “OK”, “NG” and “NG”. In other words, before error correction is performed, a different process can be performed on a place immediately after one original becomes missing, which is out of pattern. For example, a place where the error has occurred can be located by performing a check, by use of all the processing instruction sheets as described in Embodiment 1 or 2, on a set of originals which precedes immediately before a set of originals whose check results agree with the pattern. Note that, as described above, when the inclusion relationship exists, it is difficult in some cases to locate a place where the error has occurred even though all the processing instruction sheets are used. For this reason, the CPU may request the user to check image data on the set of originals on which the check has been performed immediately before the set of originals whose check results agree with the pattern by: extracting the image data from the RAM or the HDD 13; and showing the image data to the user through the display part in the operator unit 16.

Steps S509 and S510 are the same processes as those shown in FIG. 4.

As described above, according to Embodiment 3, patterns which are likely to occur when an error takes place are beforehand predicted by use of inclusion relationship information on multiple processing instruction sheets included in a scan ticket. Thereby, in the case where an inclusion relationship (s) exists among the processing instruction sheets, it is possible to inhibit deterioration in the reliability due to an error (s) such as a missing original as well. Furthermore, it is also possible to discriminate which error occurs out of one missing original, two missing originals and the like. Moreover, it is possible to correct an error thus discriminated, and thus to continue performing the subsequent check process, too.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-279577, filed Dec. 9, 2009, which is hereby incorporated by reference herein in its entirety.

What is claimed is:

1. An image processing apparatus comprising:
reading unit configured to read a plurality of sets each including a plurality of originals having different formats and a predetermined arrangement order, and to obtain a piece of image data on each original;
storage unit configured to store as many pieces of processing instruction information as the originals in one set in association with information on the arrangement order of the originals, each of the pieces of the processing instruction information being used for performing a check process on entered items in one original;
check unit configured to perform the check process on the obtained piece of image data on an original by applying one of the pieces of processing instruction information, which are stored in the storage unit, on a basis of the information on the arrangement order of the originals;
control unit configured to make control for the check to be performed by applying a different one of the pieces of processing instruction information, which are stored in the storage unit, in a case where a result of the check process indicates an error; and
unit configured to perform a subsequent check by shifting correspondence between the originals and the pieces of processing instruction information applied to the originals in a case where a result of the check performed by applying the different pieces of processing instruction information indicates no error in the check performed by the control unit.

2. The image processing apparatus according to claim 1, further comprising:
calculation unit configured to calculate a check score for each of the pieces of processing instruction information which have been applied to a piece of image data on one original; and
check result selecting unit configured to select a check result, which has a highest check score among check scores calculated by the calculation unit, as a check result of the piece of image data, wherein
in a case where the result of the check process indicates an error, the control unit makes control for the check to be performed on the piece of image data on one original by sequentially applying the different pieces of processing instruction information which are stored in the storage unit but have not been used, and which are not the pieces of processing instruction information used by the check unit, and
the check result selecting unit selects the check result of the piece of image data from check scores calculated as a result of sequential application of the pieces of processing instruction information which have not been used.

3. The image processing apparatus according to claim 1, wherein
in a case where the pieces of processing instruction information, which are stored in the storage unit, have an inclusion relationship, a check result pattern is generated from the inclusion relationship, and
in a case where the result of the check process indicates an error which agrees with the check result pattern, the control unit makes control for the check process to be performed on a set of originals, for which the error is indicated, by applying the pieces of processing instruction information having the arrangement order to be applied being changed according to the agreeing check result pattern.

4. The image processing apparatus according to claim 3, wherein
in a case where the error disappears from the one set of originals as a result of the check process performed by applying the pieces of processing instruction information having the arrangement order being changed, the check is performed on a set of originals to be checked after the one set of originals by applying the pieces of processing instruction information having arrangement order being changed.

5. The image processing apparatus according to claim 1, wherein
the as many pieces of processing instruction information to be stored as the plurality of originals having the different formats and the predetermined arrangement order, as well as the information on the arrangement order of the originals are coded and outputted, as a scan ticket, onto one paper medium, and are stored in the storage unit by reading the outputted scan ticket.

6. The image processing apparatus according to claim 3,
the as many pieces of processing instruction information to be stored as the plurality of originals having the different formats and the predetermined arrangement order, as well as the information on the arrangement order of the originals and the check result pattern are coded and outputted, as a scan ticket, onto one paper medium, and are stored in the storage means by reading the outputted scan ticket.

7. A method for controlling an image processing apparatus comprising the steps of:
reading a plurality of sets each including a plurality of originals having different formats and a predetermined arrangement order, and acquiring a piece of image data on each original;
storing as many pieces of processing instruction information as the originals in one set in association with information on the arrangement order of the originals, each of the pieces of the processing instruction information being used for performing a check process on entered items in one original;
performing the check process on the obtained piece of image data on an original by applying one of the pieces of processing instruction information, which are stored in the storing step, on a basis of the information on the arrangement order of the originals;
making control for the check to be performed by applying a different one of the pieces of processing instruction information, which are stored in the storing step, in a case where a result of the check process indicates an error; and
performing a subsequent check by shifting correspondence between the originals and the pieces of processing instruction information applied to the originals in a case where a result of the check performed by applying the different pieces of processing instruction information indicates no error in the check performed by the control step.

8. A program configured to cause a computer to perform the method for controlling an image processing apparatus according to claim 7.
